(19) United States
(12) Patent Application Publication
(10) Pub. No.: US 2020/0329056 A1
(43) Pub. Date: Oct. 15, 2020

(54) TRUSTED ADVISOR FOR IMPROVED SECURITY

(71) Applicant: Microsoft Technology Licensing, LLC, Redmond, WA (US)

(72) Inventors: Randal P. Treit, Snohomish, WA (US); Erik Wahlstrom, Sammamish, WA (US)

(21) Appl. No.: 16/384,662

(22) Filed: Apr. 15, 2019

(51) Int. Cl. H04L 29/06; H04L 29/12

(52) U.S. Cl. CPC H04L 63/1416; G06F 17/2705; H04L 63/1425; H04L 61/1564

(57) ABSTRACT

Disclosed are methods and systems for improving security via a trusted advisor. The disclosed embodiments recognize that some computer users may benefit from oversight by another individual, who may have more computer expertise and be better equipped to evaluate whether security implicating changes to a computer are appropriate. To that end, the disclosed embodiments provide for a notification to a trusted advisor in the event that particular events on the computer meet a criterion. For example, an attempt to launch or install a program having particular characteristics may benefit from a review by a trusted advisor.

### BACKGROUND

Technical support fraud is a growing problem. In this type of fraud scenario, a computer user may receive a phone call from a nefarious individual claiming to represent a well-known technology company. The individual may, for example, claim to be capable of resolving technical issues the computer user may be having with their computer.

To further this goal, the unsuspecting computer user may, at the caller's direction, download and install “troubleshooting” software that the computer user believes will assist in resolution of the issues. However, the installed software may assist the caller in subverting security protections of the computer, allowing them to gain unauthorized access. Thus, improved methods of preventing technical support fraud are desired.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is an overview diagram showing a computing device connected to a communications network according to an example embodiment.

FIG. 2 is a block diagram showing an example organization of the computing device according to at least some of the disclosed embodiments.

FIG. 3 is a block diagram showing one example implementation of a security engine.

FIG. 4 shows one example embodiment of a user interface according to an example embodiment.

FIG. 5 shows one example embodiment of a user interface that may be implemented by one or more of the disclosed embodiments.

FIG. 6 shows a notification user interface that may be implemented in one or more of the disclosed embodiments.

FIG. 7 is an example notification message that may be generated in one or more of the disclosed embodiments.

FIG. 8 shows example data structures, all or portions of which may be implemented by one or more of the disclosed embodiments.

FIG. 9 is a flowchart of a method, all or a portion of which may be implemented by one or more of the disclosed embodiments.

FIG. 10 is a flowchart of a method, all or a portion of which may be implemented by one or more of the disclosed embodiments.

FIG. 11 illustrates a block diagram of an example machine upon which any one or more of the techniques (e.g., methodologies) discussed herein may be performed in one or more of the disclosed embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

As discussed above, fraudulent technical support calls may allow a nefarious actor to gain unauthorized access to a computer. Once access is achieved, a user's personal information, such as tax returns, passwords, photographs, or other personal data may be available for exploitation. Other methods of obtaining unauthorized access to a computer may also be used by a nefarious action to gain unauthorized access to the computer. For example, a user may connect a portable storage device including malicious files to a computer. The files may then be transferred from the portable storage device to the computer's memory and executed. In some cases, computers provide for an “auto play” capability that may cause files included on a recently connected storage device to he automatically executed, further exacerbating this problem. In some cases, a user may be provided with a message, for example, via email, text message, or other messaging service. The message may be presented to appear innocent, but upon selecting the included link, one or more actions may be initiated that can potentially compromise the security of the computer. For example, in some cases, selecting a link may initiate a download of a malicious file. Alternatively, selecting the link may present a user interface on the user's computer that causes malicious code to run within a browser application displaying the user interface.

In some cases, a computer's network interface may be scanned by a malicious actor to identify vulnerabilities in how the computer is connected to the network. In some cases, access to the computer may be obtained via network access channels or ports that are unprotected or weakly protected from nefarious access via the network.

Many computer users may have a relatively low level of computer knowledge, and thus may be easily persuaded to allow someone who claims to be acting in their best interests, to “help” them resolve technical problems they are unable to overcome independently. Some computer users may inadvertently or unintentionally reduce the security of their computer. For example, they may unintentionally change their firewall rules, disable their virus checker, install a second or redundant anti-virus program that could interference with an existing solution, or other operations.

To help counter the possibility that a computer user may place their trust, even temporarily, in a nefarious individual, or that the computer user may unintentionally make their computer vulnerable to a security exploit, the disclosed embodiments facilitate notification of a predetermined trusted advisor when changes are made to the user's computer that may have security implications. For example, in some embodiments, one or more trusted advisors may be configured for a particular account on a computer. In some aspects, an ability to create or edit this configuration may be available to individual computer users. In some other aspects, a user and/or one or more administrators of a computer may be provided with access to configure a trusted advisor for a user's account.

When changes meeting a criterion are detected, the trusted advisor may be notified, and asked to approve the change. Unlike existing solutions that may require approval of a systems administrator before any changes are made, the computer user may already have administrative privileges on their computer, as is typical with many home computer installations. The trusted advisor may not have an account on the computer in question, but may instead be queried via various messaging techniques, such as via text, email, or even voice notification.

A response indicating whether the requested change is approved or denied by the trusted advisor may similarly be received via the same messaging techniques. With this approach, there is no need to directly associate the trusted advisor for a computer account with that account. For example, it is not necessary to give the trusted advisor access to any computer resources of the account, such as computer files, processing resources, or any other resource that is available via authentication credentials of the account. Instead, the trusted advisor's contact information is provided via configuration information, and used to contact the trusted advisor when their approval of a security related operation is appropriate. In some embodiments, multiple trusted advisors may be configured for a particular account. The multiple trusted advisors may be arranged in a priority order, with the trusted advisors notified according to the priority order until a response is obtained.

By providing for a trusted advisor to review changes to a computer that may have security implications, the disclosed subject matter provides for many technical benefits. For example, the responsibility for ensuring a secure computing environment may be broadened via use of the disclosed subject matter. This responsibility may include additional individuals, configured as technical advisors, which are more easily made aware of potential modifications to a computer. These additional individuals provide for additional expertise and focus being brought to bear on the issue. This may result in technical benefits in providing an overall increase in the security of the computer. Additionally, because a larger number of individuals may be available to review potential modifications to a computer, those modifications may be reviewed in less time than might otherwise be possible if, for example, only computer administrators could review such modifications.

Furthermore, the disclosed subject matter provides for the application of more expertise for consumer or small business computer systems that do not have the benefit of being included within a large enterprise organization, where higher levels of expertise are more typically available. While consumer and/or small business users may not have access to enterprise security professionals, an ability to rely on one or more trusted advisors via the disclosed subject matter may provide a significant improvement in oversight of their computers, resulting in more secure and robust computing environments.

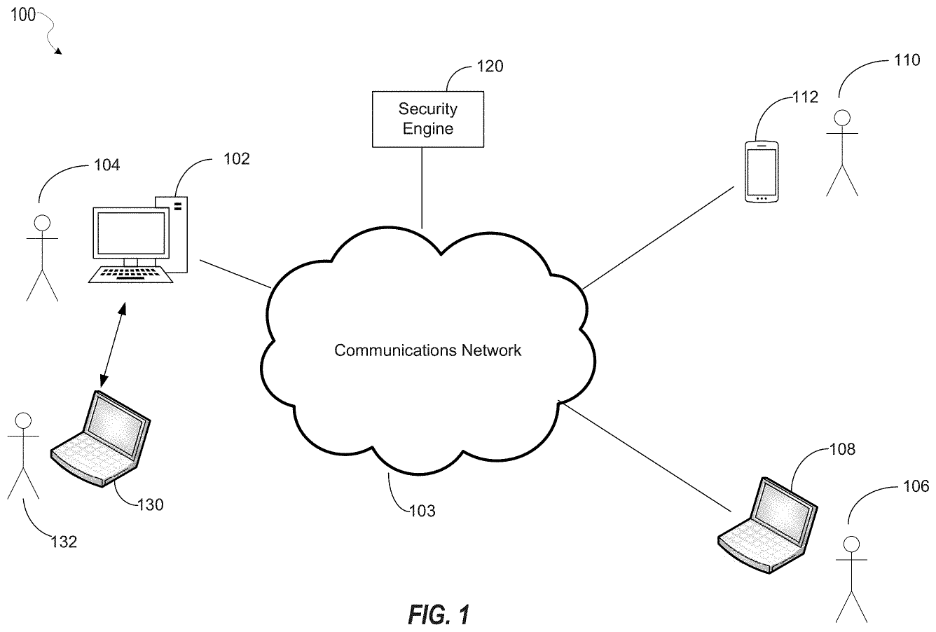

FIG. 1 is an overview diagram showing a computing device 102 connected to a communications network 103. The computing device 102 may be owned and/or operated by a computer user 104. The computer user 104 may be contacted by a nefarious actor 106. The nefarious actor 106 may convince the computer user 104 to provide access to the client device 102 to the nefarious actor 106. For example, the nefarious actor 106 may be granted access to the computing device 102 via their laptop 108.

Embodiments of this disclosure may detect certain security related events that the nefarious actor may convince the computer user 104 to perform on their computing device 102. For example, the nefarious actor 106 may convince the computer user 104 to install one or more programs on their computing device 102. Upon detecting these actions, the disclosed embodiments notify a trusted advisor 110 via email, text, phone, or other notification method, which may be communicated to the trusted advisor 110 via their smart phone 112. The computing device 102 may be supported by a security engine 120 in detecting these security related events. The computing device 102 may be in network communication with the security engine 120. For example, the security engine may provide a configuration user interface to facilitate configuration of trusted advisor information. Furthermore, the security engine 120 may provide for provision of a policy to define how security related event is handled on the computing device 102.

FIG. 1 also shows an administrative console 130 and an administrator 132. The administrative console 130 may be used by a second user having administrative credentials to perform administrative functions on the computing device 102 in some aspects. For example, in some aspects, the administrative console 130 may be used by an administrator to configure a trusted advisor for the computing device 102. In other aspects, the user 104 may configure their own trusted advisor via the computing device 102.

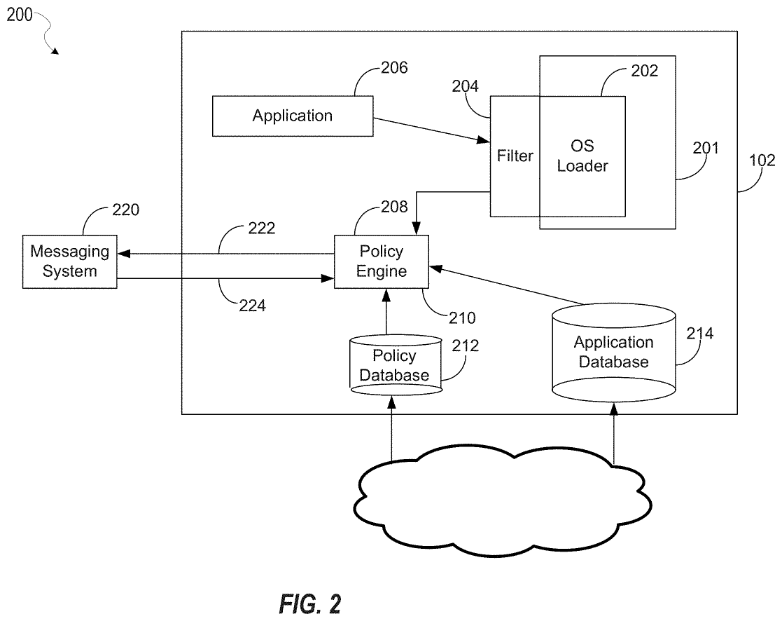

FIG. 2 is a block diagram showing an example organization of the computing device 102 according to at least some of the disclosed embodiments. The computing device 102 includes an operating system 201, operating system loader 202, filter 204, application 206, policy engine 208, policy database 210, and application database 212. The operating system loader 202 may load application programs that run on the computing device 102. The operating system 201 for the computing device may include provisions for installation of one or more “filters,” that may be notified by the operating system upon a selectable set of operating system events, such as an attempt to perform an operation requiring administrative privileges, such as an operation to edit firewall rules, disable an anti-virus filter, write to a master boot record, update a basic input/output system (BIOS). The events may also include an attempt to install or launch/execute a program, or to open a file for example. The filter 204 may be one such filter, configured to intercept or receive notifications of security related events, such as file opens and or file executions performed by the operating system loader 202 or other operating system 201 components (depending on the type of operation to be detected by the filter 204). For example, the filter 204 may be notified when the operating system loader 202 attempts to load the application 206 for execution.

Upon notification of the security related operation, such as an attempt to load the application 206 or install the application 206, the filter 202 may communicate the attempt to perform the operation to the policy engine 208. The filter 204 may provide one or more data identifying the security related operation to the policy engine 208. The policy engine 208 then attempts to identify the characterize the security related operation. If the security related operation is an attempt to launch or install an application, the disclosed embodiments may characterize the application by searching an application database 214. In some embodiments, the application database may store information that uniquely identifies a particular application, such as the application 206. For example, the application database 214 may store application hashes of known applications, along with other information about the identified applications, such as a type of the application, a publisher of the application, or other information. Hashes stored may include one or more of a cyclic redundancy check, checksum, a SHA-1 hash, or other hashes known in the art. A hash function generally maps data of an arbitrary size (e.g. data in an application file, such as a .exe file) into a data of fixed size. All or a portion of an application may be hashed to form an identifier of the application. In some aspects, multiple hashes, formed from different portion of the application or via different hash algorithms, may be used to identify the application.

The application database 214 may also provide a mapping from identified application to a category of the application. For example, each application identified in the application database may be categorized as a word processing application, spreadsheet application, gaming application, browser application, malicious application, or any other application category, which may be vary by embodiment.

Once a categorization of the security related operation (e.g. such as an attempt to launch or install the application 206) is determined, the policy engine 208 determines whether to proceed with the operation based on the category of the operation. To accomplish this, the policy engine 208 consults a policy database 212, which indicates which categories of security related operations may be performed without approval from a trusted advisor and which security related operation require such approval. If the security related operation requires approval, the policy engine 208 then communicates with the trusted advisor via a messaging system 220. For example, the messaging system 220 may support messaging via email, text message, or any other messaging technology. The policy engine 208 sends an approval request 222 to the messaging system 220. The approval request 222 is addressed to an address specified for the trusted advisor for the computing device 102. A response 224 may then be received indicating whether the request 222 is approved or not.

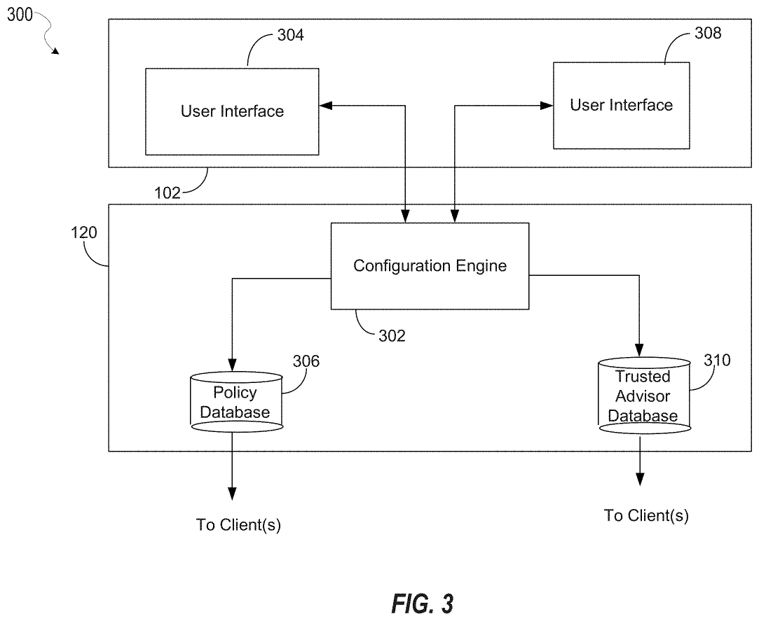

FIG. 3 is a block diagram showing one example implementation of the security engine 120. The security engine 120 includes a configuration engine 302. In some aspects, the security engine 120 displays one or more of user interfaces 304 and/or 308. The user interfaces 304 and/or 308 may be used to establish trusted advisor configuration information for a first computer account. in some aspects, the user interfaces 304 and/or 308 may be displayed on the client device 102 via a session established via credentials for the first computer account. The first computer account may or may not have administrative credentials for the first computer account. In some other aspects, the security engine 120 displays one or more of the user interfaces 304 and/or 308 on the administrative console 130, discussed above with respect to FIG. 1. In these aspects, the user interfaces 304 and/or 308 may be displayed within a session established via credentials for a second computer account. The second computer account has administrative credentials for the first account in these aspects, which may allow the second computer account to modify trusted advisor configuration information for the first computer account.

The security engine 120 may also include a policy database 306. The policy database 306 may be equivalent to the policy database 212, discussed above with respect to FIG. 2. In some aspects, the policy database 306 may store policy information for multiple client devices 102, while the policy database 212 may store only policy information for a single client device 102.

The configuration engine 302 displays the user interface 304. The user interface 304 is configured to receive configuration information (input) defining trusted advisors for one or more accounts of one or more computer devices. The user interface 304, which may be running on the client device 102 or alternatively on the administrator console 130, is configured to transmit the trusted advisor information to the configuration engine 302.

The configuration engine 302 may also display a user interface 308. The user interface 308 is also configured to receive input defining trusted advisor information, such as contact information for a trusted advisor. This information may be received from the user interface 308, which may be running on either the computing device 102 or the administrative console 130, and stored in a trusted advisor database 310 by the configuration engine 302. All or a portion of the security engine 120 may, in some embodiments, operate within the computing device 102. In some other embodiments, the security engine 120 may operate on a computing device different from the computing device 102, such as a back-end or cloud-based server.

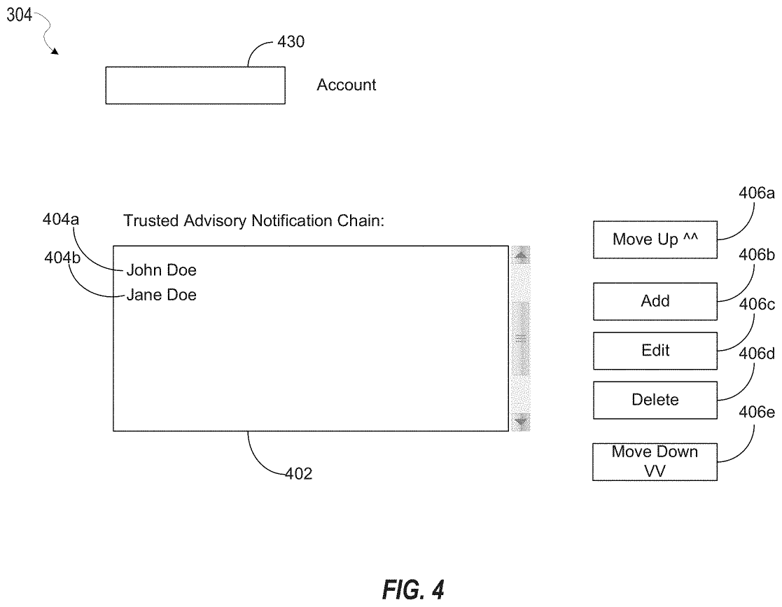

FIG. 4 shows one example embodiment of the user interface 304. The user interface 304 includes a scrollable trusted advisor list control 402. The example user interface 304 of FIG. 4 shows two trusted advisor names. 404a and 404b. The user interface is configured to receive input to add, edit, or delete entries in the trusted advisor list 402 via controls 406b, 406c, and 406d respectively. The controls 406a and 406e are configured to move an entry in the trusted advisor list 402 up or down respectively relative to other entries in the trusted advisor list 402.

The user interface 304 is also shown with an account field 430. The account field 430 may be conditionally displayed based on administrative privileges of an account under which the user interface 304 is running. For example, if the user interface 304 is running under an account with administrative privileges, and there are multiple accounts configured on the computer, then the account field 430 may be displayed and/or enabled to provide for specification of an account for which trusted advisor(s) are being configured via the user interface 304. If the user interface 304 is running on the computing device 102, which may have only a single account and/or the user interface 304 is running under an account having no administrate privileges, then the account field 430 may not be displayed and/or enabled in some embodiments.

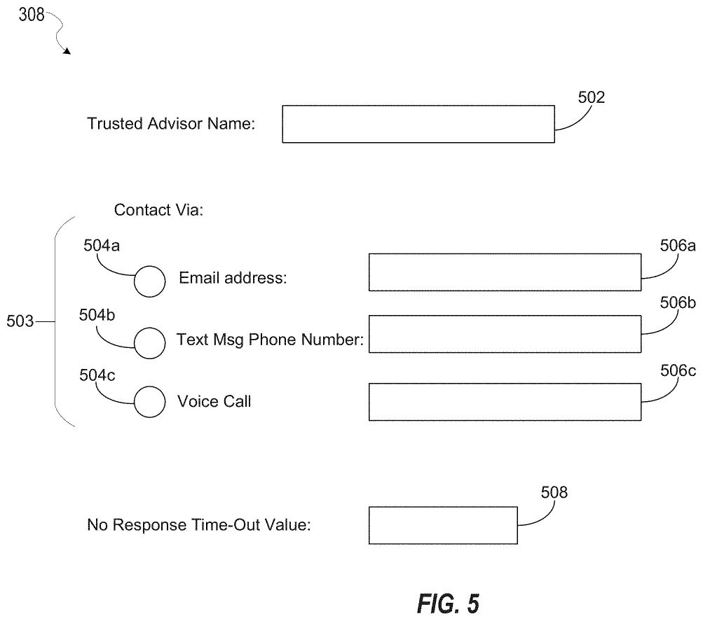

FIG. 5 shows one example embodiment of a user interface 308 that may be implemented by one or more of the disclosed embodiments. The user interface 308 illustrated in FIG. 5 may be displayed in response to the “add” control 406b discussed above with respect to FIG. 4. The user interface 308 includes a control 502 configured to receive data defining a name of a trusted advisor. The name may be displayed in the trusted advisor list 402, such as illustrated by the names 404a and 404b. The user interface also includes a group of selectable controls 503, illustrated in FIG. 5 as radio controls 504a-c. The selectable controls 503 may provide for a selection of one of the controls 504a-c exclusively. The selected control defines a method of contacting the trusted advisor named by the control 502. As shown, the controls 504a-c may be used to select email, text, or voice methods of contact respectively. The controls 506a-c receive input defining information providing for the selected method of contact. For example, control 506a is configured to receive input defining an email address, control 506b is configured to receive input defining a text messaging address, and control 506c is configured to receive input defining a phone number to support voice contact.

The user interface 308 also includes a control 508 configured to receive input defining a time out value for the trusted advisor. The time-out value 508 defines how much time the disclosed embodiments may wait after contacting the trusted advisor before a next trusted advisor in the trusted advisor list 402 is contacted if no response is received.

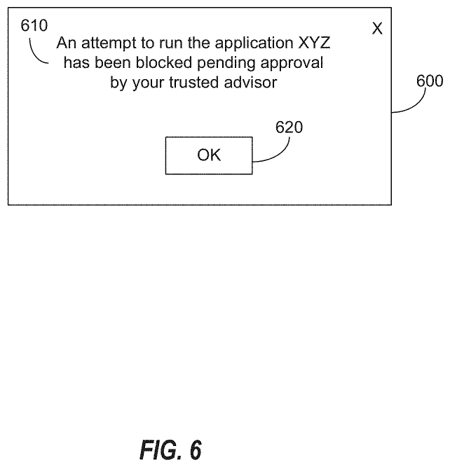

FIG. 6 shows a notification user interface 600 that may be implemented in one or more of the disclosed embodiments. The notification user interface 600 may he displayed on a computing device 102 after a launch attempt of an application (e.g. 206). In some aspects, the user interface 600 may be displayed by the policy engine 208. The user interface 600 includes a message 610 indicating the nature of the notification. The user interface 600 also includes a selectable control 620. Input selecting the control 620 may close the user interface 600.

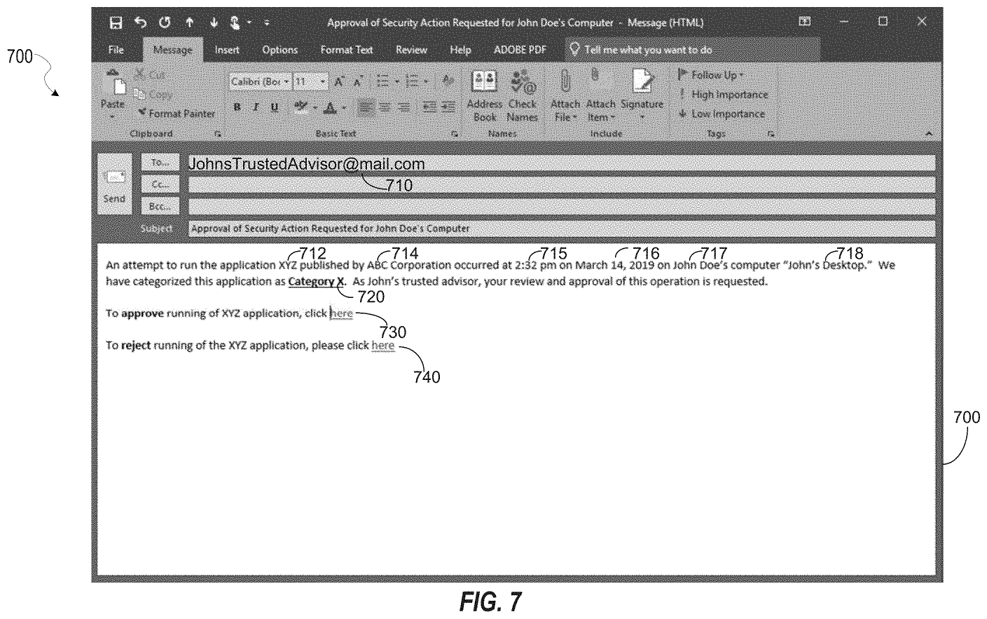

FIG. 7 is an example notification message that may be generated in one or more of the disclosed embodiments. The notification message 700 is illustrated as an email message. Other embodiments may provide notifications in text message form, as access to a web hook URL, or as voice/sound phone call notifications.

The notification 700 is sent to an address 710, in this case, an email address. The notification 700 includes a message 711. The message 711 includes indications of an application for which a launch was attempted 712, a publisher of the application 714, a time of the attempt 715, a date of the attempt 716, a name of a user that attempted to launch the application 717, and a name of the computer on which the launch was attempted 718.

The notification 700 may also include selectable controls configured to generate input indicating whether the request to launch the application 712 is approved (e.g. via control 730) or disapproved (e.g. via control 740).

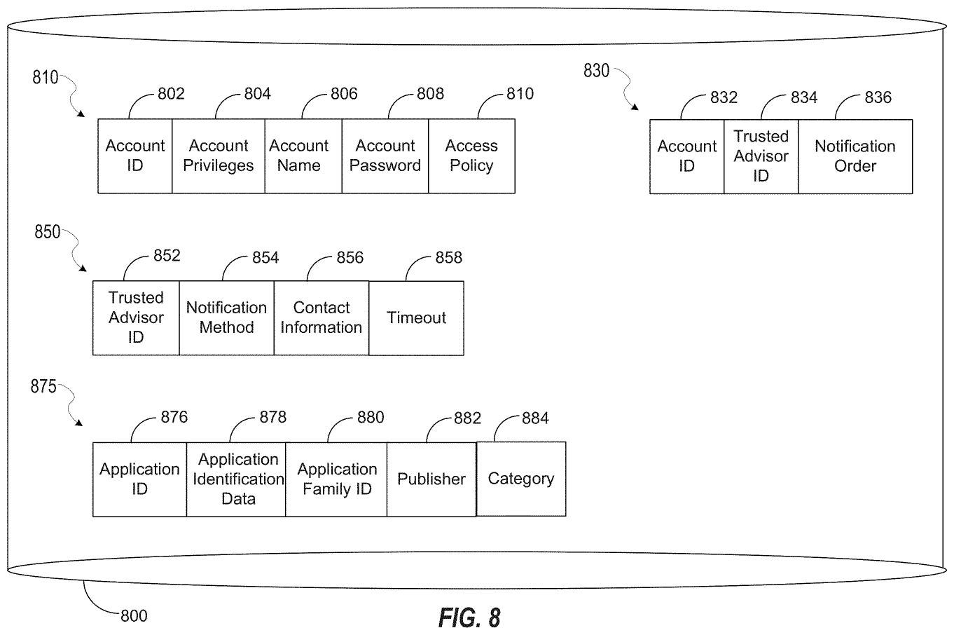

FIG. 8 shows example data structures, all or portions of which may be implemented by one or more of the disclosed embodiments. While the data structures are illustrated and discussed below as relational database tables, one of skill would understand that alternative implementations of data may be used in some embodiments. For example, at least portions of the illustrated data structures may be implemented using in memory structures such as linked lists, queues, trees. Unstructured data stores may be used in some embodiments.

FIG. 8 shows a data store 800 that includes an account table 810, a trusted advisor table 830, a trusted advisor detail table 850, and an application table 875. The account table 810 includes an account identifier field 802, account privileges field 804, account name field 806, an account password field 808, and an access policy field 810. The account identifier field 802 stores information that uniquely identifies an account. The account privileges field 804 stores data indicating privileges of the account (identified via 802). For example, the account privileges field 804 may indicate whether the account has administrative privileges or not. The account name field 806 indicates a name of the account (e.g. 802). The account password field 808 stores a password for the account (e.g. 802). The access policy field 810 indicates types or categories of applications which may be run by the account (e.g. 802). The access policy field 810 may further indicate categories which require approval of a trusted advisor, and which categories are forbidden regardless of any input from a trusted advisor. For example, applications categorized as malware may be unconditionally forbidden, while hacking tools may be allowed with trusted advisor permission, as indicated by access policy 810.

The trusted advisor table 830 associates zero or more trusted advisors with accounts included in the account table 810. The trusted advisor table 830 includes an account identifier field 832, trusted advisor identifier 834, and a notification order field 836. The account identifier 832 uniquely identifies an account and may be cross referenced with the account id 802. The trusted advisor identifier 834 uniquely identifies a trusted advisor, and may be cross referenced with the trusted advisor identifier 852, discussed below with respect to the trusted advisor detail table 850. The notification order field 836 identifies a notification order for the trusted advisor 834 with respect to the account 832. In other words, the trusted advisor table 830 may include multiple entries for a particular account id, indicating multiple different trusted advisors (e.g. 834). The notification order 836 identifies in which order the multiple trusted advisors for a single account are notified.

The trusted advisor detail table 850 includes a trusted advisor identifier 852, notification method 854, contact information 856, and timeout value 858. The trusted advisor identifier 852 uniquely identifies a trusted advisor and may be cross referenced with the trusted advisor ID 834. The notification method 854 indicates how to contact the trusted advisor (identified via trusted advisor identifier 852). For example, the notification method 854 may indicate whether the trusted advisor should be contacted via email, text, web hook. voice phone, or some other method. The contact information 856 stores contact information for the trusted advisor (e.g. 852). The contact information 856 may indicate one or more of a phone number, address, email address, uniform resource locator for a web hook, or other contact information. The timeout value 858 indicates a time period after which a next trusted advisor should be contacted if no response is received from the trusted advisor indicated by the id 852.

The application table 875 includes an application identifier 876, application identification data 878, application family identifier 880, a publisher 882, and a category 884. The application identifier 876 uniquely identifies a particular application. The application identification data 878 indicates one or more data that may be used to identify the application, For example, the application identification data 878 may indicate one or more hash values for the application identified via 876. The identification data 878 may also include one or more application meta data fields. The application family identifier 880 identifies a family that the application (e.g. 876) is included in. For example, a suite of applications may include multiple separate applications. The family identifier 880 may identify the suite while the application identifier 876 identifies each individual application. The publisher field 882 identifies a publisher of the application. The category field 884 identifies a category for the application. A category may include, for example, games, word processing, spreadsheet, browser, or other category.

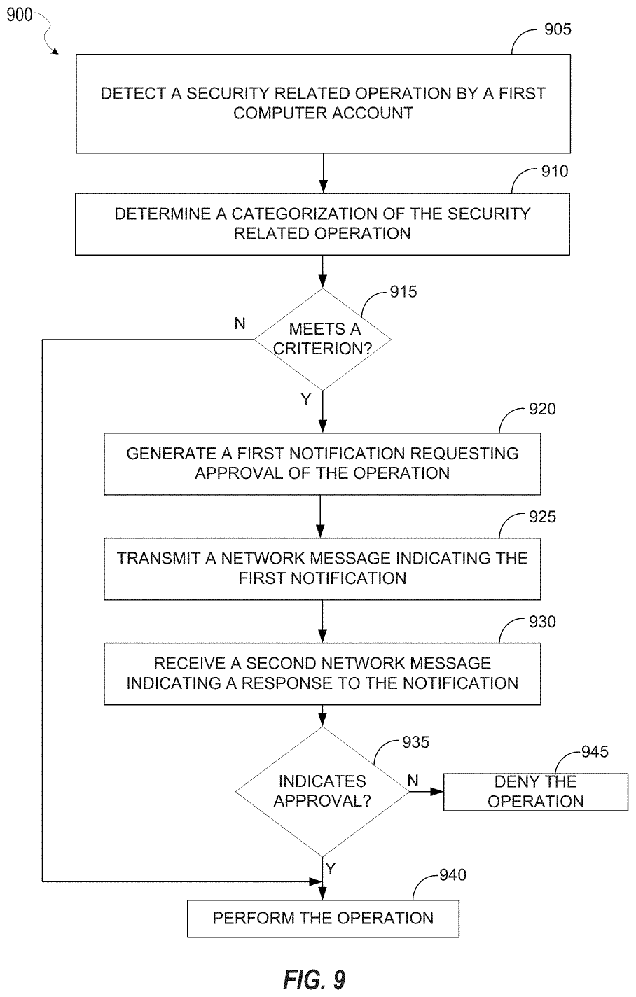

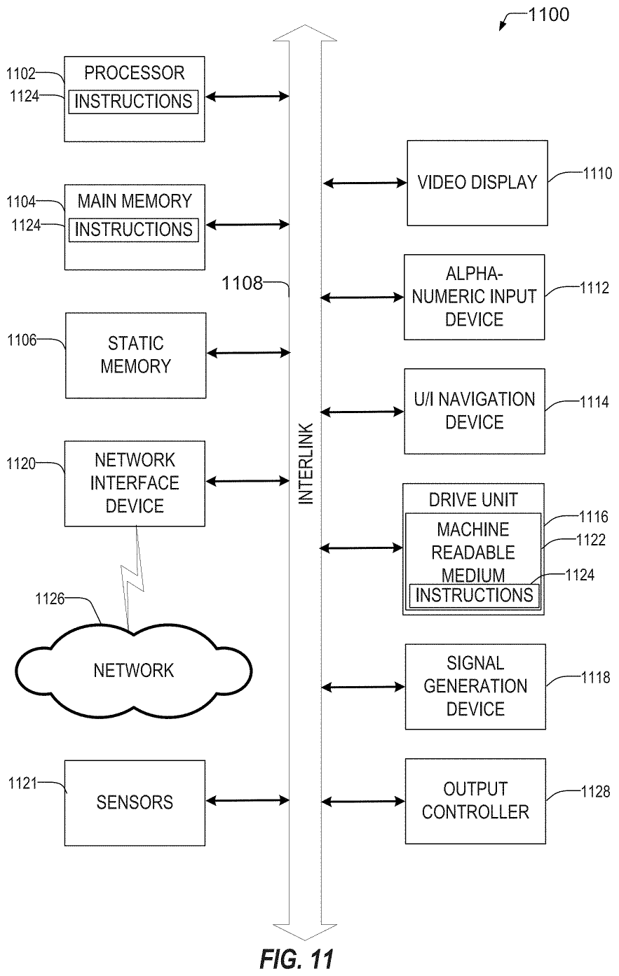

FIG. 9 is a flowchart of a method, all or a portion of which may be implemented by one or more of the disclosed embodiments. In some aspects, instructions stored in an electronic hardware memory may configure hardware processing circuitry to perform one or more of the functions discussed below with respect to FIG. 9. In some aspects, the machine 1100, discussed below with respect to FIG. 11, may be configured to implement one or more of the functions discussed below. For example, the instructions 1124 may configure the processor 1102 to perform one or more of the functions discussed below with respect to FIG. 9.

In operation 905, a security related operation is detected on a computing device. The security related operation is attempted within a session established within a computer account, which may or may not have administrative privileges for the computer account. In some aspects, the administrative privileges may allow full access to all operating system and hardware features of the device.

In some aspects, the security related operation is an attempt to launch or install a program on the computing device. In some aspects, the operation detected in operation 905 may include edits to security parameters of a computing device. For example, in these aspects, the security related operation detected in operation 905 may include operations to disable an anti-virus program, firewall, or other security related application, edits to firewall or virus screening policy, basic input/output system (BIOS) updates, switching out of an operating system safe mode, updates to a master boot record (MBR), installation of key loggers or other risky programs, changes to domain name services, or, as discussed above, installation of a security related program, such as a remote access application, anti-virus program, firewall, or other security implicated program.

In operation 910, a categorization of the security related operation is determined. For example, in some aspects, operation 910 may determine identifying characteristics or information of the security related operation. As discussed above, when the operation is an attempt to launch or install an application, in some aspects, a filter 204 may intercept a load operation of the application (e.g. application 206) and perform a hash or scan other characteristics of the application that can assist in unique identification of the application. In some aspects, the hash may be based on data of the application itself. In some aspects, the hash may also be based on metadata included in an application file storing the application. Based on these characteristics and/or hashes of the application, a categorization database (e.g. 875) may be consulted to determine a category (e.g. 884) for the application (e.g. matched via 878). In some aspects, when the security related operation is an attempt to launch or install an application program, operation 910 determines whether the application program is a potentially unwanted program (PUA). A program may be categorized as a potentially unwanted program via security or parental control products, and operation 910 may consult data generated by these products to determine whether the program is a PUA.

In some aspects, dynamic profiling of the application may be used, at least in part, to determine a categorization. Dynamic profiling of an application allows for a program to run such that it may be observed and its characteristics identified based on the run time behavior. This may be generally referred to as behavioral profiling. These aspects may allow the program to run for some predetermined period of time or for some predetermined number of executable instructions. Operation of the program may be monitored in order to detect one or more events, such as function calls, branches, write operations and/or read operations. The type of events, their respective order, and timing of each event may provide a signature of the program's operation, which may be compared to signatures of other known applications.

In some aspects, a machine learning model may be used to identify similarities between a signature of a known application and a signature of the program. For example, the model may be trained using known application signatures and their respective categories. When the program of operation 905 attempts to launch, a new signature for the program is generated and provided to the model. The model may then provide an indication of a category of the program based on the program's signature and its similarity to other signatures provided to the model during training. In some aspects, detonation modeling may be used. For example, detonation modeling may run unknown applications within a virtual machine when monitoring their operations. Using this technique, harm done by the unknown application is limited to the virtual machine, which may be destroyed after the test and its resources recycled for use in a new virtual machine.

Decision operation 915 determines whether the categorization determined in operation 910 meets a criterion. In some aspects, the criterion may be specific to the account (e.g. 810). For example, the criterion may indicate an operation to launch an application categorized as known malware is unconditionally prevented from running, while an operation to launch a second application categorized as “remote access” requires permission of a trusted advisor before the operation detected in operation 905 may continue. If the criterion is not met, process 900 moves from decision operation 915 to operation 940, discussed in more detail below.

If the criterion is met, then process 900 moves to operation 920, which generates a first notification. The first notification requests approval for the detected operation. Operation 920 may include identifying a trusted advisor for the account attempting the operation. In some aspects, operation 920 may search a trusted advisor data store (e.g. 830) for trusted advisors (e.g. 834) associated with the account (e.g. 832). A trusted advisor in an appropriate notification order may be selected (e.g. via 836). For example, if this is a first notification for the operation detected in operation 905, a trusted advisor 834 indicating a first notification order (e.g. via 836) may be identified. A notification method and contact information for the trusted advisor may then be identified (e.g. via 850). The notification may then be generated based on the identified notification method. For example, if the trusted advisor is to be notified via email, an email notification is generated by operation 920. If the trusted advisor is to be notified via text, a text message notification is generated by operation 920. The notification may be generated to request approval for the operation detected in operation 905. For example, the notification may be generated to request approval in a similar manner as at described above with respect to FIG. 7.

In operation 925, a network message is transmitted indicating the notification. For example, if text message notification is used, a text message is transmitted to the trusted advisor in operation 925. If email message notification is used, an email message is transmitted in operation 920. The email message is addressed to an email address of the trusted advisor.

In operation 930, a second network message is received. The second network message indicates a response to the notification. In some aspects, the response indicates whether a request included in the generated notification of operation 920 is approved or rejected. Thus, operation 930 may include parsing the response to determine whether the request is approved or rejected. In some aspects, the approval or rejection may be indicated via access to a web hook specified in the generated notification. In these aspects, the second network message is a network request to access the web hook URL.

Decision operation 935 determines whether the response indicated approval. If approval was indicated, process 900 moves to operation 940, which performs the security related operation detected in operation 905. If the request is denied, process 900 moves from decision operation 935 to operation 945, which rejects or denies the security related operation detected in operation 905.

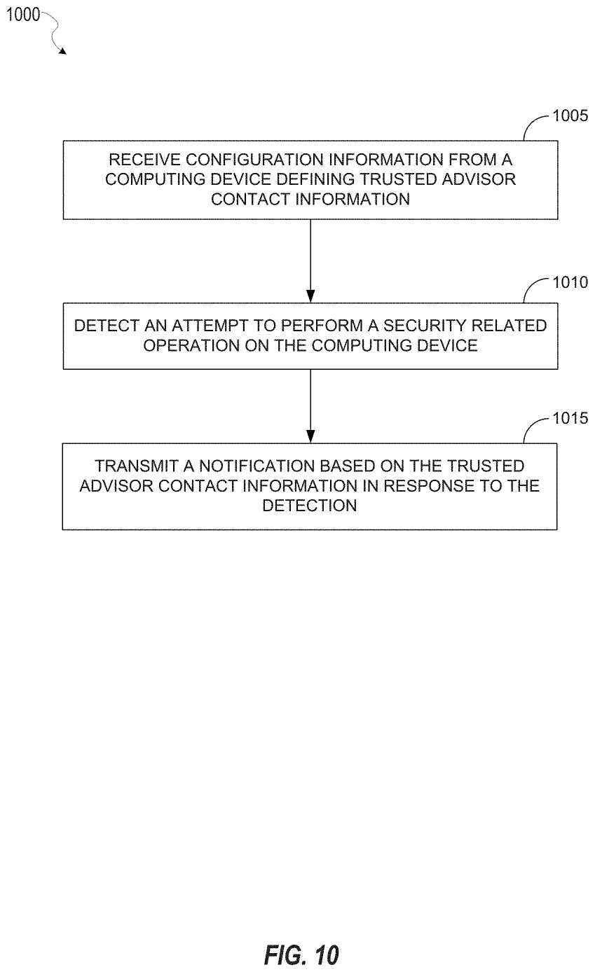

FIG. 10 is a flowchart of a method, all or a portion of which may be implemented by one or more of the disclosed embodiments. In some aspects, instructions stored in an electronic hardware memory may configure hardware processing circuitry to perform one or more of the functions discussed below with respect to FIG. 11. In some aspects, the machine 1100, discussed below with respect to FIG. 11, may be configured to implement one or more of the functions discussed below. For example, the instructions 1124 may configure the processor 1102 to perform one or more of the functions discussed below with respect to FIG. 10. In some aspects, one or more of the functions discussed below with respect to FIG. 10 may be included in the process 900, discussed above with respect to FIG. 9.

In operation 1005, configuration information is received from a computing device. The configuration information defines trusted advisor contact information. For example, as discussed above, the user interfaces 304 and/or 308 may be displayed on a computing device, such as the computing device 102 discussed above with respect to FIG. 1. The user interface(s) are configured to receive input defining the configuration information, such as any one or more of the fields discussed above with respect to user interfaces 304 and/or 308. The configuration information may be stored in a trusted advisor data store, such as the trusted advisor data store 310 discussed above. The trusted advisor configuration information may be represented via any one or more of the fields of the trusted advisor detail table 850 in some aspects.

In operation 1010, an attempt to perform a security related operation on the computing device is detected. As discussed above, the security related operation may include modification of a virus scanning program, changes to firewall rules, changes to account privileges, a change to an account password, an attempt to run or launch an application, or other operations that could potentially effect security of the computing device.

In some aspects, the operation may relate to selection of an external link that will initiate downloading of one or more files to the computer performing operation 1010. For example, in some examples, a phishing email may be sent to a user of the computing device 102. Upon reading the phishing email, a link included in the phishing email may be selected, causing the computing device 102 to attempt to retrieve the resource identified by the link.

In operation 1015, a notification is transmitted based on the trusted advisor contact information. The transmission is in response to the detection of the event. The notification transmitted in operation 1015 may include one or more of the features discussed above with respect to operation 920 and/or 925.

FIG. 11 illustrates a block diagram of an example machine 1100 upon which any one or more of the techniques (e.g., methodologies) discussed herein may perform. In alternative embodiments, the machine 1100 may operate as a standalone device or may be connected (e.g., networked) to other machines. In a networked deployment, the machine 1100 may operate in the capacity of a server machine, a client machine, or both in server-client network environments. In an example, the machine 1100 may act as a peer machine in peer-to-peer (P2P) (or other distributed) network environment. The machine 1100 may be a personal computer (PC), a tablet PC, a set-top box (STB), a personal digital assistant (PDA), a mobile telephone, a smart phone, a web appliance, a network router, switch or bridge, a server computer, a database, conference room equipment, or any machine capable of executing instructions (sequential or otherwise) that specify actions to be taken by that machine. In various embodiments, machine 1100 may perform one or more of the processes described above with respect to FIGS. 1-10. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms (all referred to hereinafter as “modules”). Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Machine (e.g., computer system) 1100 may include a hardware processor 1102 (e.g., a central processing unit (CPU), a graphics processing unit (GPU), a hardware processor core, or any combination thereof), a main memory 1104 and a static memory 1106, some or all of which may communicate with each other via an interlink (e.g., bus) 1108. The machine 1100 may further include a display unit 1110, an alphanumeric input device 1112 (e.g., a keyboard), and a user interface (UI) navigation device 1114 (e.g., a mouse). In an example, the display unit 1110, input device 1112 and UI navigation device 1114 may be a touch screen display. The machine 1100 may additionally include a storage device (e.g., drive unit) 1116, a signal generation device 1118 (e.g., a speaker), a network interface device 1120, and one or more sensors 1121, such as a global positioning system (GPS) sensor, compass, accelerometer, or other sensor. The machine 1100 may include an output controller 1128, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 1116 may include a machine readable medium 1122 on which is stored one or more sets of data structures or instructions 1124 (e.g., software) embodying or utilized by any one or more of the techniques or functions described herein. The instructions 1124 may also reside, completely or at least partially, within the main memory 1104, within static memory 1106, or within the hardware processor 1102 during execution thereof by the machine 1100. In an example, one or any combination of the hardware processor 1102, the main memory 1104, the static memory 1106, or the storage device 1116 may constitute machine readable media.

While the machine readable medium 1122 is illustrated as a single medium, the term “machine readable medium” may include a single medium or multiple media (e.g., a centralized or distributed database, and/or associated caches and servers) configured to store the one or more instructions 1124.

The term “machine readable medium” may include any medium that is capable of storing, encoding, or carrying instructions for execution by the machine 1100 and that cause the machine 1100 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine readable media. In some examples, machine readable media may include machine readable media that is not a transitory propagating signal.

The instructions 1124 may further be transmitted or received over a communications network 1126 using a transmission medium via the network interface device 1120. The machine 1100 may communicate with one or more other machines utilizing any one of a number of transfer protocols (e.g., frame relay, Internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 1120 may include one or more physical jacks (e.g., Ethernet, coaxial, or phone jacks) or one or more antennas to connect to the communications network 1126. In an example, the network interface device 1120 may include a plurality of antennas to wirelessly communicate using at least one of single-input multiple-output (SIMO), multiple-input multiple-output (MIMO), or multiple-input single-output (MISO) techniques. In some examples, the network interface device 1120 may wirelessly communicate using Multiple User MIMO techniques.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client, or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations.

Example 1 is a method, comprising: detecting an attempt to perform a security related operation on a computing device; determining a categorization of the security related operation; in response to the categorization meeting a criterion, generating a first notification requesting approval for the security related operation; transmitting a network message indicating the first notification; receiving a second network message indicating a response to the notification; and conditionally performing the security related operation based on the response.

In Example 2, the subject matter of Example 1 optionally includes receiving input defining a messaging address for the first notification, wherein the first notification is generated to be addressed to the messaging address.

In Example 3, the subject matter of Example 2 optionally includes wherein the detection of the security related operation is performed by a computing device, and the input defining the messaging address is received by the computing device.

In Example 4, the subject matter of any one or more of Examples 2-3 optionally include wherein the detection of the attempt to perform the security related operation is performed by a computing device, and the input defining the messaging address is received from the computing device by a second device.

In Example 5, the subject matter of any one or more of Examples 1-4 optionally include wherein the transmitting of the network message comprises one or more of transmitting an email, or a text message, or accessing a web hook indicating the first notification.

In Example 6, the subject matter of any one or more of Examples 1-5 optionally include parsing the response to determine whether the response indicates an approval of the security related operation, and performing the security related operation in response to an indicated approval.

In Example 7, the subject matter of any one or more of Examples 1-6 optionally include generating a second notification requesting approval for the security related operation in response to a predetermined amount of time elapsing after the generation of the first notification before the response is received.

In Example 8, the subject matter of any one or more of Examples 5-7 optionally include wherein the second notification is generated to a different messaging address than the first notification.

In Example 9, the subject matter of any one or more of Examples 1-8 optionally include wherein receiving the second network message includes receiving a request to access a web hook URL, the request indicating whether the request is approved as a parameter to the access request.

In Example 10, the subject matter of any one or more of Examples 1-9 optionally include wherein receiving the second network message includes receiving an email or a text message including the response, and parsing the received email or text message to determine whether the response approves performance of the security related operation, wherein the conditional performance of the security related operation is responsive to the determination.

In Example 11, the subject matter of any one or more of Examples 1-10 optionally include deferring the security related operation until a response is received or a predetermined amount of time elapses after the attempt to perform the security related operation.

In Example 12, the subject matter of any one or more of Examples 1-11 optionally include rejecting the attempt to perform the security related operation in response to a predetermined period of time elapsing without a response being received.

Example 13 is a system, comprising: hardware processing circuitry; one or more hardware memories storing instructions that when executed configure the hardware processing circuitry to perform operations comprising: detecting an attempt to perform a security related operation on a computing device; determining a categorization of the security related operation; in response to the categorization meeting a criterion, generating a first notification requesting approval for the performance of the security related operation; transmitting a network message indicating the first notification; receiving a second network message indicating a response to the notification; and conditionally performing the security related operation based on the response.

in Example 14, the subject matter of Example 13 optionally includes the operations further comprising receiving input defining a messaging address for the first notification, wherein the first notification is generated to be addressed to the messaging address.

In Example 15, the subject matter of Example 14 optionally includes wherein the detection of the attempt to perform the security related operation is performed by a computing device, and the input defining the messaging address is received by the computing device.

In Example 16, the subject matter of any one or more of Examples 13-15 optionally include wherein the transmitting of the network message comprises one or more of transmitting an email, or a text message, or accessing a web hook indicating the first notification.

In Example 17, the subject matter of any one or more of Examples 13-16 optionally include the operations further comprising parsing the response to determine whether the response indicates an approval of the security related operation, and performing the security related operation in response to an indicated approval.

In Example 18, the subject matter of any one or more of Examples 13-17 optionally include the operations further comprising generating a second notification requesting approval for the security related operation in response to a predetermined amount of time elapsing after the generation of the first notification before the response is received.

In Example 19, the subject matter of Example 18 optionally includes wherein the second notification is generated to a different messaging address than the first notification.

In Example 20, the subject matter of any one or more of Examples 13-19 optionally include wherein receiving the second network message includes receiving a request to access a web hook URL, the request indicating whether the request is approved as a parameter to the access request.

In Example 21, the subject matter of any one or more of Examples 13-20 optionally include wherein receiving the second network message includes receiving an email or a text message including the response, and parsing the received email or text message to determine whether the response approves performance of the security related operation, wherein the conditional launching responsive to the determination.

In Example 22, the subject matter of any one or more of Examples 13-21 optionally include the operations further comprising deferring the performance of the security related operation until a response is received or a predetermined amount of time elapses after the attempt to perform the security related operation.

In Example 23, the subject matter of any one or more of Examples 13-22 optionally include the operations further comprising rejecting the attempt to perform the security related operation in response to a predetermined period of time elapsing without a response being received.

Example 24 is a non-transitory computer readable storage medium comprising instructions that when executed configure hardware processing circuitry to perform operations comprising: detecting an attempt to launch a program on a device by a first computer account; determining a categorization of the program; in response to the categorization meeting a criterion, generating a first notification requesting approval for the program launch; transmitting a network message indicating the first notification; receiving a second network message indicating a response to the notification; and conditionally launching the program based on the response.

In Example 25, the subject matter of Example 24 optionally includes the operations further comprising receiving input defining a messaging address for the first notification, wherein the first notification is generated to be addressed to the messaging address.

In Example 26, the subject matter of Example 25 optionally includes wherein the detection of the attempt to launch the program is performed by a computing device, and the input defining the messaging address is received by the computing device.

In Example 27, the subject matter of any one or more of Examples 24-26 optionally include wherein the transmitting of the network message comprises one or more of transmitting an email, or a text message, or accessing a web hook indicating the first notification.

In Example 28, the subject matter of any one or more of Examples 24-27 optionally include the operations further comprising parsing the response to determine whether the response indicates an approval of the program launch, and launching the program in response to an indicated approval.

In Example 29, the subject matter of any one or more of Examples 24-28 optionally include the operations further comprising generating a second notification requesting approval for the program launch in response to a predetermined amount of time elapsing after the generation of the first notification before the response is received.

In Example 30, the subject matter of Example 29 optionally includes wherein the second notification is generated to a different messaging address than the first notification.

In Example 31, the subject matter of any one or more of Examples 24-30 optionally include wherein receiving the second network message includes receiving a request to access a web hook URL, the request indicating whether the request is approved as a parameter to the access request.

In Example 32, the subject matter of any one or more of Examples 24-31 optionally include wherein receiving the second network message includes receiving an email or a text message including the response, and parsing the received email or text message to determine whether the response approves launching of the program, wherein the conditional launching is responsive to the determination.

In Example 33, the subject matter of any one or more of Examples 24-32 optionally include the operations further comprising deferring the launch of the program until a response is received or a predetermined amount of time elapses after the launch attempt.

In Example 34, the subject matter of any one or more of Examples 24-33 optionally include the operations further comprising rejecting the launch attempt in response to a predetermined period of time elapsing without a response being received.

Example 35 is an apparatus, comprising: means for detecting an attempt to perform a security related operation on a computing device; means for determining a categorization of the security related operation; means for generating a first notification requesting approval for the security related operation in response to the categorization meeting a criterion; means for transmitting a network message indicating the first notification; means for receiving a second network message indicating a response to the notification; and means for conditionally performing the security related operation based on the response.

In Example 36, the subject matter of Example 35 optionally includes means for receiving input defining a messaging address for the first notification, wherein the first notification is generated to be addressed to the messaging address.

In Example 37, the subject matter of Example 36 optionally includes wherein the detection of the security related operation is performed by a computing device, and the input defining the messaging address is received by the computing device.

In Example 38, the subject matter of any one or more of Examples 36-37 optionally include wherein the means for detection of the attempt to perform the security related operation is a computing device, and the input defining the messaging address is received from the computing device by a second device.

In Example 39, the subject matter of any one or more of Examples 35-38 optionally include wherein the means for transmitting the network message is configured to transmit the network message as one or more of an email, or a text message, or accessing a web hook indicating the first notification.

In Example 40, the subject matter of any one or more of Examples 35-39 optionally include means for parsing the response to determine whether the response indicates an approval of the security related operation, and performing the security related operation in response to an indicated approval.

In Example 41, the subject matter of any one or more of Examples 35-40 optionally include means for generating a second notification requesting approval for the security related operation in response to a predetermined amount of time elapsing after the generation of the first notification before the response is received.

In Example 42, the subject matter of Example 41 optionally includes wherein the second notification is generated to a different messaging address than the first notification.

In Example 43, the subject matter of any one or more of Examples 35-42 optionally include wherein receiving the second network message includes receiving a request to access a web hook URL, the request indicating whether the request is approved as a parameter to the access request.

In Example 44, the subject matter of any one or more of Examples 35-43 optionally include wherein receiving the second network message includes receiving an email or a text message including the response, and parsing the received email or text message to determine whether the response approves performance of the security related operation, wherein the conditional performance of the security related operation is responsive to the determination.

In Example 45, the subject matter of any one or more of Examples 35-44 optionally include means for deferring the security related operation until a response is received or a predetermined amount of time elapses after the attempt to perform the security related operation.

In Example 46, the subject matter of any one or more of Examples 35-45 optionally include means for rejecting the attempt to perform the security related operation in response to a predetermined period of time elapsing without a response being received.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; flash memory; etc.

1. A method, comprising:
detecting an attempt to perform a security elated operation on a computing device;
determining a categorization of the security related operation;
in response to the categorization meeting a criterion, generating a first notification requesting approval for the security related operation;
transmitting a network message indicating the first notification;
receiving a second network message indicating a response to the notification; and
conditionally performing the security related operation based on the response.

2. The method of claim 1, further comprising receiving input defining a messaging address for the first notification, wherein the first notification is generated to be addressed to the messaging address.

3. The method of claim 2, wherein the detection of the security related operation is performed by a computing device, and the input defining the messaging address is received by the computing device.

1. The method of claim 2, wherein the detection of the attempt to perform the security related operation is performed by a computing device, and the input defining the messaging address is received from the computing device by a second device.

5. The method of claim 1, further comprising generating a second notification requesting approval for the security related operation in response to a predetermined amount of time elapsing after the generation of the first notification before the response is received.

6. The method of claim 1, wherein receiving the second network message includes receiving a request to access a web hook URL, the request indicating whether the request is approved as a parameter to the access request.

7. The method of claim 1, wherein receiving the second network message includes receiving an email or a text message including the response, and parsing the received email or text message to determine whether the response approves performance of the security related operation, wherein the conditional performance of the security related operation is responsive to the determination.

8. The method of claim 1, further comprising rejecting the attempt to perform the security related operation in response to a predetermined period of time elapsing without a response being received.

9. A system, comprising:
hardware processing circuitry;
one or more hardware memories storing instructions that when executed configure the hardware processing circuitry to perform operations comprising:
detecting an attempt to perform a security related operation on a computing device;
determining a categorization of the security related operation;
in response to the categorization meeting a criterion, generating a first notification requesting approval for the performance of the security related operation;
transmitting a network message indicating the first notification;
receiving a second network message indicating a response to the notification; and
conditionally performing the security related operation based on the response.

10. The system of claim 9, the operations further comprising receiving input defining a messaging address for the first notification, wherein the first notification is generated to be addressed to the messaging address.

11. The system of claim 10, wherein the detection of the attempt to perform the security related operation is performed by a computing device, and the input defining the messaging address is received by the computing device.

12. The system of claim 9, wherein the transmitting of the network message comprises one or more of transmitting an email, or a text message, or accessing a web hook indicating the first notification.

13. The system of claim 9, the operations further comprising parsing the response to determine whether the response indicates an approval of the security related operation, and performing the security related operation in response to an indicated approval.

14. The system of claim 9, the operations further comprising generating a second notification requesting approval for the security related operation in response to a predetermined amount of time elapsing after the generation of the first notification before the response is received.

15. The system of claim 14, wherein the second notification is generated to a different messaging address than the first notification.

16. The system of claim 9, wherein receiving the second network message includes receiving a request to access a web hook URL, the request indicating whether the request is approved as a parameter to the access request.

17. The system of claim 9, wherein receiving the second network message includes receiving an email or a text message including the response, and parsing the received email or text message to determine whether the response approves performance of the security related operation, wherein the conditional launching is responsive to the determination.

18. The system of claim 9, the operations further comprising deferring the performance of the security related operation until a response is received or a predetermined amount of time elapses after the attempt to perform the security related operation.

19. The system of claim 9, the operations further comprising rejecting the attempt to perform the security related operation in response to a predetermined period of time elapsing without a response being received.

20. A non-transitory computer readable storage medium comprising instructions that when executed configure hardware processing circuitry to perform operations comprising:
detecting an attempt to launch or install a program on a device by a first computer account;
determining a categorization of the program;
in response to the categorization meeting a criterion, generating a first notification requesting approval for the program launch;
transmitting a network message indicating the first notification;
receiving a second network message indicating a response to the notification; and
conditionally launching or installing the program based on the response.
